(19) United States
(12) Patent Application Publication
(10) Pub. No.: US 2010/0293116 A1
(43) Pub. Date: Nov. 18, 2010

(54) URL AND ANCHOR TEXT ANALYSIS FOR FOCUSED CRAWLING

(76) Inventors: Shi Cong Feng, Beijing (CN); Yuhong Xiong, Mountain View, CA (US); Li Zhang, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/680,903

(22) PCT Filed: Nov. 8, 2007
(86) PCT No.: PCT/CN07/71031

§ 371 Date: Mar. 31, 2010

(51) Int. Cl. G06F 15/18; G06F 17/30

(52) U.S. Cl. 706/12; 707/709; 707/E17.108

(57) ABSTRACT

Systems and methods of URL and anchor text analysis for focused crawling are disclosed. In an exemplary embodiment, a method may include training a focused crawler by: obtaining a training set of at least URL's or anchor text for a website, computing a score for the training set, and extracting a plurality of features of the training set, and computing a score for each of the plurality of features. The features identify key information contained in the website. The method may also include executing a trained focused crawler on other websites.

### BACKGROUND

Although there are a large number of websites on the Internet or World Wide Web (www), users often are only interested in information on specific web pages from some websites. For example, students, professionals, and educators may want to easily find educational materials, like online courses from a particular university. The marketing department of an enterprise may want to know the evaluations of customers, the comparison between their products and those from their competitors, and other relevant product information. Accordingly, various search engines are available for specific websites.

One approach to discovering domain-specific information is to crawl all of the web pages on a website and use a classification tool to identify the desired or “target” web pages. The crawler keeps a set of Uniform Resource Locators (URLs) extracted from the pages it has already downloaded, and downloads the pages pointed to by those URLs in a certain order. Such an approach is only feasible with a large amount of computing resources, or if the website only has few web pages.

A more efficient way to discover domain-specific information is known as focused crawling. Focused crawling is often used for domain-specific web resource discovery and its main goal is to efficiently and effectively find topic-specific web content while utilizing limited resources. A focused crawler tries to decide whether a URL refers to a target page, or may lead to a target page in a few hops. If so, the URL should be followed. If not, the URL should be discarded. One challenge of designing an efficient focused crawler is to design a classifier that can make this decision quickly with high precision.

Most conventional crawlers use the Breadth First Search (BFS) approach to crawl websites. Using this approach, a crawler has to download all the pages in the first several levels from the root of the website before reaching the target page. This is time and resource consuming. On the other hand, the active learning approach such as Dynamic PageRank, has to maintain a dynamic sub-graph to model the link structure of downloaded web pages. It requires large amount of computation and memory resources and can become a bottleneck in the focused crawling.

There are many classic classification algorithms, such as SVM, Naive Bayesian, and Maximum Entropy methods. But they usually involve complicated modeling and learning processes.

### BRIEF DESCRIPTION OF THE DRAWINGS

FIG. 1 is a high-level diagram of an exemplary networked computer system in which URL and/or anchor text analysis may be implemented for focused crawling.

FIG. 2 is an organizational layout for an exemplary website.

FIG. 3 is a flowchart illustrating exemplary training stage operations for URL and anchor text analysis for focused crawling.

FIG. 4 is a flowchart illustrating exemplary execution stage operations for URL and anchor text analysis for focused crawling.

### DETAILED DESCRIPTION

Systems and methods of Uniform Resource Locator (URL) and/or anchor text analysis for focused crawling are disclosed. Exemplary embodiments enable a focused crawler find target pages quickly by identifying the target pages among all the candidate pages, and also the web pages that may lead to target pages. The URL based classification method is much simpler, more intuitive, and more efficient as compared to other existing classification methods. Moreover, the URL classification method is significantly faster because only the URL and/or anchor text of a web page is used for classification. The URL and anchor text for a web page is typically much shorter than the entire content of the web page. Hence, a decision can be made faster than typical focused crawling algorithms which analyze the entire contents of a web page. Also in exemplary embodiments, a static learning approach may be implemented. That is, after a URL classifier is “trained,” the scores of URL features are not changed, and the score of a candidate URL can be computed quickly using pre-computed feature scores.

### Exemplary Systems

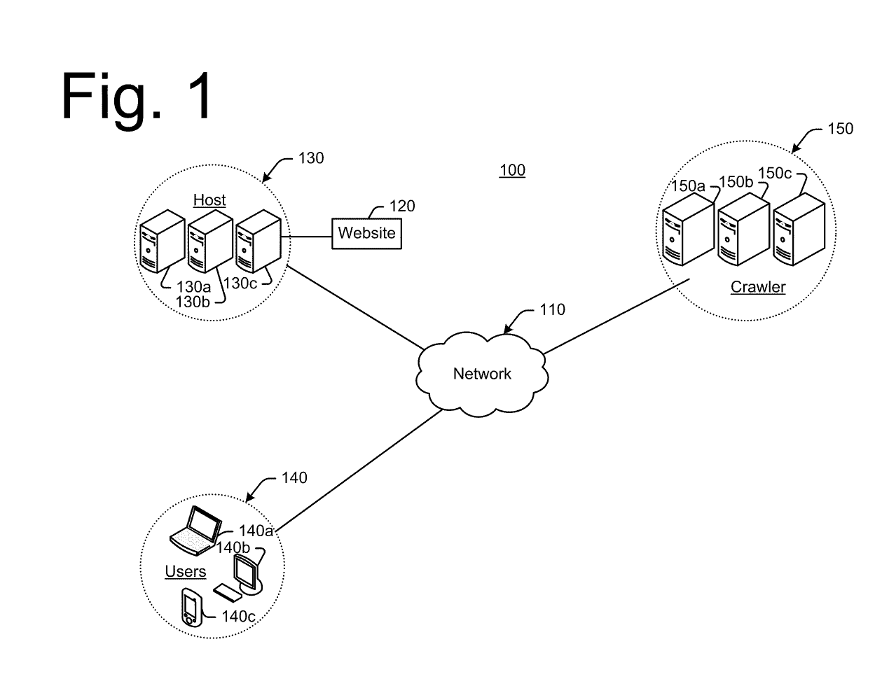

FIG. 1 is a high-level illustration of an exemplary networked computer system 100 (e.g., via the Internet) in which URL and/or anchor text analysis may be implemented for focused crawling. The networked computer system 100 may include one or more communication networks 110, such as a local area network (LAN) and/or wide area network (WAN), for connecting one or more websites 120 at one or more host 130 (e.g., servers 130a-c) to one or more user 140 (e.g., client computers 140a-c).

The term “client” as used herein (e.g., client computers 140a-c) refers to one or more computing device through which one or more users 140 may access the network 110. Clients may include any of a wide variety of computing systems, such as a stand-alone personal desktop or laptop computer (PC), workstation, personal digital assistant (PDA), or appliance, to name only a few examples. Each of the client computing devices may include memory, storage, and a degree of data processing capability at least sufficient to manage a connection to the network 110, either directly or indirectly. Client computing devices may connect to network 110 via a communication connection, such as a dial-up, cable, or DSL connection via an Internet service provider (ISP).

The focused crawling operations described herein may be implemented by the host 130 (e.g., servers 130a-c which also host the website 120) or by a third party crawler 150 (e.g., servers 150a-c) in the networked computer system 100. In either case, the servers may execute program code which enables focused crawling of one or more website 120 in the networked computer system 100. The results may then be stored (e.g., by crawler 150 or elsewhere in the network) and accessed on demand to assist the user 140 when searching the website 120.

The term “server” as used herein (e.g., servers 130a-c or servers 150a-c) refers to one or more computing systems with computer-readable storage. The server may be provided on the network 110 via a communication connection, such as a dial-up, cable, or DSL connection via an Internet service provider (ISP). The server may be accessed directly via the network 110, or via a network site. In an exemplary embodiment, the website 120 may also include a web portal on a third-party venue (e.g., a commercial Internet site) which facilitates a connection for one or more server via a back-end link or other direct link. The servers may also provide services to other computing or data processing systems or devices. For example, the servers may also provide transaction processing services for users 140.

When the server is “hosting” the website 120, it is referred to herein as the host 130 regardless of whether the server is from the cluster of servers 130a-c or the cluster of servers 150a-c. Likewise, when the server is executing program code for focused crawling, it is referred to herein as the crawler 150 regardless of whether the server is from the cluster of servers 130a-c or the cluster of servers 150a-c.

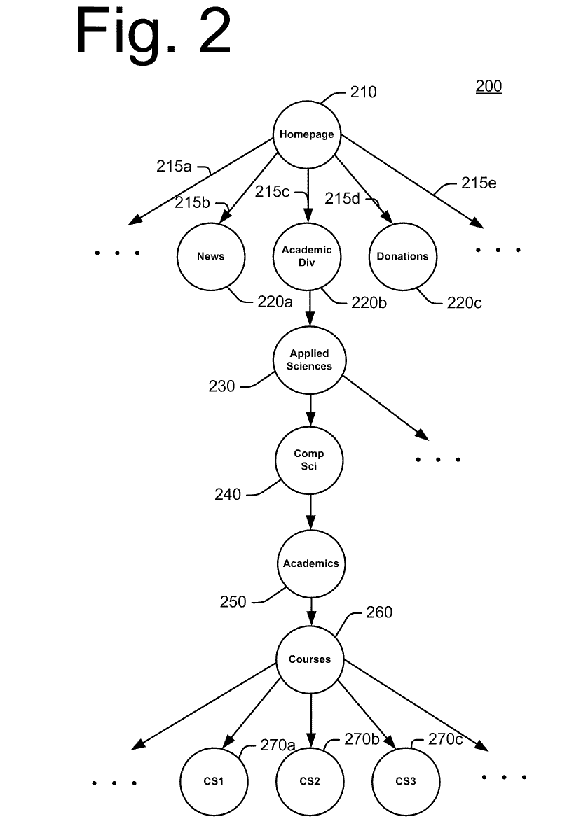

In focused crawling, the program code needs to efficiently identify target web pages. This is often difficult to do because target web pages are typically located “far away” from the website's home page. For example, web pages for university courses are on average about eight web pages away from the university's home page, as illustrated in FIG. 2.

FIG. 2 is an organizational layout 200 for an exemplary website, such as the website 120 shown in FIG. 1. The online courses shown in FIG. 2 are used as an example of content domain, but it is noted that the systems and methods described herein are not limited to any particular content.

In this example, the website is a university website having a home page 210 with a number of links 215a-e to different child web pages 220a-c. At least some of the child web pages may also link to child web pages, such as web page 230, and then web pages 240-260, and so forth. The target web pages 270a-c are linked to through web page 260.

Here it can be seen that the shortest path from the university's home page 210 (the “root”) to the target web page 270a containing course information (e.g., for CS1) is <Homepage> <Academic Division> <Engineering & Applied Sciences> <Computer Sciences> <Academic> <Course Websites> <CS1>. According to the systems and methods described herein, a focused crawler is able to discover the target page 270a quickly by identifying the target pages among all the candidate pages, and also the web pages that may lead to target pages.

Briefly, scores are computed for URL features in a training dataset, and the scores of the features are then used to compute a score for each new URL a focused crawler may encounter. The URL classification method for scoring web pages based on analysis of URL and/or anchor text of the web page is described in more detail below.

### Exemplary Operations

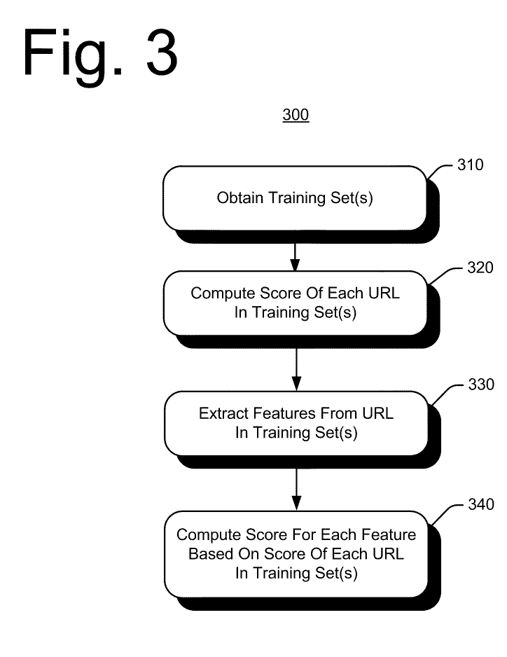

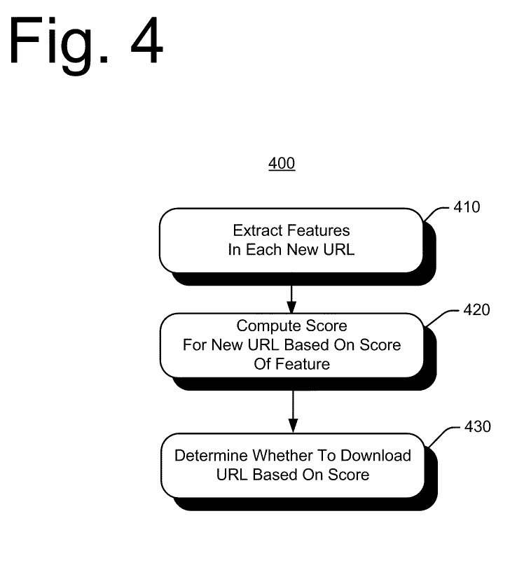

In exemplary embodiments, the operations 300 and 400 described below with reference to FIGS. 3 and 4 may be embodied as logic instructions on one or more computer-readable medium (e.g., as program code). When executed on a processor, the logic instructions cause a general purpose computing device to be programmed as a special-purpose machine that implements the described operations. In an exemplary implementation, the components and connections depicted in the figures may be used.

FIG. 3 is a flowchart illustrating exemplary training stage operations 300 for URL and anchor text analysis for focused crawling. In operation 310, a training set may be obtained. For example, the training set may be obtained by downloading several complete websites, such as the websites of one or more schools or universities.

In operation 320, a score is computed for each URL in the training set. A higher score indicates that a URL refers to a target page (which is a course page in this example), or may lead to a target page by having to follow only a few links. There are several ways to compute the scores.

In one example, the scores may be computed by manual labeling. That is, each URL is manually labeled as a course page or non-course page. A high score may be assigned to course pages and a low score may be assigned to non-course pages. In another example, the scores may be computed by automatic labeling. That is, a software classifier may perform the labeling based on the content of each web page. In yet another example, the scores may be computed using a link structure analysis. That is, an algorithm is implemented to compute a score for each web page and each linked web page based on which other web pages are linked to or from a particular web page.

In operation 330, features are extracted from each URL in the training set. The features of a URL capture the key information contained in the URL with respect to focused crawling. Features may include, for example, URL phrases. URL phrases are the segments of a URL, separated by “/” and “.”. For example, the URL http://www.a.edu/b.index contains the phrases: “http”, “www”, “a”, “edu”, “b”, and “index”. Features may also include, for example, multiple words concatenated into one phrase and separated into individual features. For example, the phrase “cscourses” in the URL http://www.a.edu/cscourses.html can be broken down into “cs” and “courses”. Other features may also include, for example, stemmed words, the position of a phrase in a URL.

Other features may also be implemented. The features may be based on a co-appearance relationship. For example, if a URL contains “class”, it usually points to a course page. However, if a URL contains both “jdk” and “class”, it usually points to a Java document. The features may be based on relative positions. For example, a URL containing “class/news” is likely to be a course page, but a URL containing “news/course” is likely not. Features may also be based on patterns. For example, the course ID in many universities has the format of a few letters followed by a number, such as cs123, bio45. URLs containing such patterns are likely to be course pages. The above features are merely exemplary and are not intended to be limiting. Other features may be used.

In operation 340, a score is computed for each feature in the URL. For purposes of illustration, assume that the URL scores computed in operation 320 can be either positive or negative. A high positive score means that a URL points to a target page, or is very close to a target page. A low negative score means that a URL is not a target page, and is far away from a target page.

In any event, the score of a feature should satisfy the following criteria. Each occurrence of a feature in a URL with a positive score should make a positive contribution to the score of the feature. The more positive URLs a feature appears in, and the higher the scores of those URLs, the higher the score of the feature. Each occurrence of a feature in a URL with a negative score should make a negative contribution to the score of the feature. The more negative URLs a feature appears in, and the lower the scores of those URLs, the lower the score of the feature. Neutral features, which do not have predictive power (e.g., the phrases “http” or “edu”) should have a neutral score (e.g., zero). In addition, the more URLs a feature appears in, the higher the weight of its score (either more positive or more negative). The more spread a feature appears in positive and negative URLs, the lower the weight of its score.

There are many mathematical formulas which may be implemented to satisfy these criteria. For purposes of illustration, and not intending to be limiting, the following formulas may be implemented:

$$Score ( p ) = \frac{1}{{f}_{1} + {f}_{2}} ( {\sum }_{i = 1}^{{f}_{1}} Score ( U R {L}_{i} ) - {\sum }_{j = 1}^{{f}_{2}} ratio * Score ( U R {L}_{j} ) * \frac{log ( {f}_{1} + {f}_{2} )}{1 + σ}$$

Where, Score(p): score of a feature;
f₁: number of positive URLs containing feature p in training set;
f₂: number of negative URLs that contain feature p in training set;
Score(URLᵢ): score of i^{th} positive URL that contains feature p;
Score(URLⱼ): score off' negative URL that contains feature p;
ratio: total number of positive URLs in the training set divided by total number of negative URLs in the training set; and
σ: standard deviation of scores of URLs containing feature p

That is,

$$σ = \sqrt{\frac{1}{n} {\sum }_{i = 0}^{n} {( {x}_{i} - \overline{x} )}^{2}}$$

Where, n: number of URLs containing feature p;
x: score of the i^{th} URL containing p; and
x bar: average score of the n URLs.

After training the system as discussed above with reference to operations 300 and exemplary formulas which may be implemented, the URL and anchor text analysis may be executed for focused crawling on any of a wide variety of websites. Exemplary operations for executing are described in more detail with reference now to FIG. 4.

FIG. 4 is a flowchart illustrating exemplary execution stage operations 400 for URL and anchor text analysis for focused crawling. The focused crawler performs these operations when crawling a new website (e.g., after being trained).

In operation 410, features may be extracted from each new URL, similar to the extraction operation 310 during training, but for a new website. In operation 420, a score may be computed for each new URL. The URL score may be computed based on the scores of its features obtained in operation 340 during the training stage. An exemplary way to compute the URL score is to add up the scores of its features, e.g., using the following formula:

$$Score ( U R L ) = \frac{1}{n} {\sum }_{i = 0}^{n} Score ( {p}_{i} )$$

Where, n: number of features in the URL; and

pᵢ: The i^{th} feature contained in the URL.

In operation 430, a determination is made whether to download a URL based on its score. In an exemplary embodiment, the determination is made using a fixed threshold on the score. In another exemplary embodiment, all of the URLs are ranked by their scores and downloaded in the same order until a predetermined number of pages are downloaded (or time has passed, or other parameter).

The embodiments shown and described herein are intended only for purposes of illustration of exemplary systems and methods and are not intended to be limiting. In addition, the operations and examples shown and described herein are provided to illustrate exemplary implementations of URL and anchor text analysis for focused crawling. It is noted that the operations are not limited to those shown. Other operations may also be implemented. Still other embodiments of URL and anchor text analysis for focused crawling are also contemplated, as will be readily appreciated by those having ordinary skill in the art after becoming familiar with the teachings herein.

By way of example, it will be readily appreciated to those having ordinary skill in the art after becoming familiar with the teachings herein that variations to the above operations may also be implemented. For example, instead of using static training data to compute feature scores, a focused crawler may dynamically update the feature scores when crawling a website. That is, the crawler may use the web pages already downloaded as a training set, and update the feature scores periodically, and use the updated scores to crawl the remaining pages.

It will also be readily apparent to those having ordinary skill in the art after becoming familiar with the teachings herein that similar operations may also be implemented to include analysis of a web page by extracting and scoring features from the anchor text.

In addition to the specific embodiments explicitly set forth herein, other aspects and implementations will be apparent to those skilled in the art from consideration of the specification disclosed herein.

1. A method of Uniform Resource Locator (URL) and anchor text analysis for focused crawling, comprising:
training a focused crawler by:
obtaining a training set for a website;
computing a score for the training set of at least URL's or anchor text;
extracting a plurality of features of the training set, the features identifying key information contained in the website; and
computing a score for each of the plurality of features; and
executing a trained focused crawler on other websites.

2. The method of claim 1 wherein obtaining the training set is by downloading a plurality of complete websites related to a type of website for focused crawling.

3. The method of claim 1 wherein a higher score indicates the URL refers to a target page, or the URL leads quickly to a target page.

4. The method of claim 1 wherein computing the score is by manual labeling, or by automatic labeling using a software classifier based on content of each web page in the website, or by link structure analysis.

5. The method of claim 1 wherein features include phrases, multiple words concatenated into one phrase and separated into individual features, stemmed words, position of a phrase, a co-appearance relationship, relative positions, or patterns.

6. The method of claim 1 wherein the score of a feature satisfies the following criteria: each occurrence of a feature with a positive score makes a positive contribution to the score of the feature, and each occurrence of a feature with a negative score makes a negative contribution to the score of the feature, and neutral features have a neutral score.

7. The method of claim 1 wherein more common features result in higher scores and more dispersed features result in lower scores.

8. The method of claim 1 wherein executing a trained focused crawler on other websites is by:
extracting features from each other website; and
determining whether to download a web page based on the score.

9. The method of claim 8 wherein the determination is made using a threshold.

10. The method of claim 9 wherein the threshold is after a predetermined number of pages are downloaded.

11. The method of claim 9 wherein the threshold is after a predetermined time has passed.

12. A system comprising:
a training module operating to obtain a training set for a website, compute a score for the training set, and extract a plurality of features of the training set, the features identifying key information contained in the website; and
an execution module operating to compute a score for each of the plurality of features, and crawl other websites.

13. The system of claim 12 wherein features include phrases, multiple words concatenated into one phrase and separated into individual features, stemmed words, position of a phrase, a co-appearance relationship, relative positions, or patterns.

14. The system of claim 12 wherein the score of a feature satisfies the following criteria: each occurrence of a feature with a positive score makes a positive contribution to the score of the feature, and each occurrence of a feature with a negative score makes a negative contribution to the score of the feature, and neutral features have a neutral score.

15. The system of claim 12 wherein more common features result in higher scores.

16. The system of claim 12 wherein more dispersed features result in lower scores.

17. The system of claim 12 wherein executing a trained focused crawler on other websites is by:
extracting features from each other website; and
determining whether to download a web page based on the score.

18. The system of claim 17 wherein the determination is made using a threshold.

19. The system of claim 18 wherein the threshold is after a predetermined number of pages are downloaded or after a predetermined time has passed.

20. A system for focused crawling using Uniform Resource Locator (URL) and anchor text analysis, comprising:
means for training a focused crawler by obtaining a training set of at least URLs or anchor text for a website, computing a score for the training set, and extracting a plurality of features of the training set, and computing a score for each of the plurality of features, wherein the features identify key information contained in the website; and
means for executing a trained focused crawler on other websites.
